(19) United States
(12) Patent Application Publication
(10) Pub. No.: US 2025/0364679 A1
(43) Pub. Date: Nov. 27, 2025

(54) VENTILATION SYSTEM FOR ENERGY STORAGE SYSTEMS

(71) Applicant: Caterpillar Inc., Peoria, IL (US)

(72) Inventors: Vimal B, Chennai (IN); Krishna Prasath Ramabadhran, Krishnagiri (IN); Harish M, Bangalore (IN)

(73) Assignee: Caterpillar Inc., Peoria, IL (US)

(21) Appl. No.: 18/672,200

(22) Filed: May 23, 2024

(51) Int. Cl. H01M 50/375; H01M 10/63

(52) U.S. Cl. CPC H01M 50/375; H01M 10/63

(57) ABSTRACT

A ventilation system, for an energy storage system having an enclosure and one or more battery packs accommodated in an interior volume of the enclosure, includes a ventilation assembly and a controller. The ventilation assembly is fluidly couplable with the interior volume. The controller is configured to receive an input indicative of a concentration of a flammable gas in the interior volume. Further, the controller is configured to control the ventilation assembly to operate the ventilation assembly: in a first mode, in response to the input indicating the concentration exceeding a first threshold, to facilitate venting of the flammable gas out of the interior volume; and in a second mode, in response to the input indicating the concentration exceeding a second threshold higher than the first threshold, to facilitate venting of the flammable gas and deflagration out of the interior volume.

### TECHNICAL FIELD

The present disclosure relates to battery energy storage systems (BESS). More particularly, the present disclosure relates to a ventilation system for preventing explosion in a battery energy storage system.

### BACKGROUND

Energy storage systems are widely used for storing electrical energy received from external sources, such as power plants, and distributing the electrical energy to meet the diverse power needs of commercial, industrial, and residential applications. Typically, these energy storage systems consist of one or more battery packs (made up of multiple energy storage cells) housed within an enclosure (e.g., a storage container) to protect the battery packs from external contaminants like debris, dirt, and dust.

The energy storage cells, associated with the battery packs housed within the enclosure, are prone to failures, often due to overheating or thermal runaway. Such failures of the energy storage cells may lead to the release of high-temperature, flammable gases inside the enclosure. The accumulation of such gases within the enclosure, if not properly managed and vented, may pose a risk of explosion, thereby compromising the safety of the energy storage system and its surroundings.

PCT publication no. WO 2023/124436 discloses an energy storage system and control method therefor. The energy storage system includes a box body, an energy storage device disposed inside the box body, a first sensing apparatus disposed inside the box body and configured to sense a concentration of a combustible gas inside the box body, and a ventilation apparatus disposed on the box body, and a control apparatus. The ventilation apparatus is configured to exhaust the combustible gas out of the box body. The control apparatus communicatively coupled to the first sensing unit and the ventilation unit. The control apparatus is configured to receive first sensing information indicating the concentration of the combustible gas from the first sensing unit and, on the basis of the first sensing information, generate a signal used to control the ventilation unit.

### SUMMARY OF THE INVENTION

In one aspect, the disclosure relates to a ventilation system for an energy storage system. The energy storge system includes an enclosure and one or more battery packs accommodated in an interior volume of the enclosure. The ventilation system includes a ventilation assembly and a controller. The ventilation assembly is fluidly couplable with the interior volume. The controller is configured to receive an input indicative of a concentration of a flammable gas in the interior volume. Further, the controller is configured to control the ventilation assembly to operate the ventilation assembly in a first mode, in response to the input indicating the concentration exceeding a first threshold, to facilitate venting of the flammable gas out of the interior volume. In addition, the controller is configured to control the ventilation assembly to operate the ventilation assembly in a second mode, in response to the input indicating the concentration exceeding a second threshold higher than the first threshold, to facilitate venting of the flammable gas and deflagration out of the interior volume.

In another aspect, the disclosure relates to a method for preventing explosion in an energy storage system. The energy storage system includes an enclosure and one or more battery packs accommodated in an interior volume of the enclosure. The method includes fluidly coupling a ventilation assembly with the interior volume of the enclosure. Further, the method includes receiving, by a controller, an input indicative of a concentration of a flammable gas in the interior volume. Furthermore, the method includes controlling, by the controller, the ventilation assembly to operate the ventilation assembly in a first mode, in response to the input indicating the concentration exceeding a first threshold, to facilitate venting of the flammable gas out of the interior volume. In addition, the method includes controlling, by the controller, the ventilation assembly to operate the ventilation assembly in a second mode, in response to the input indicating the concentration exceeding a second threshold higher than the first threshold, to facilitate venting of the flammable gas and deflagration out of the interior volume.

In yet another aspect, the disclosure relates to an energy storage system. The energy storage system includes an enclosure defining an interior volume, one or more battery packs accommodated in the interior volume, and a ventilation system. The ventilation system includes a ventilation assembly and a controller. The ventilation assembly is fluidly couplable with the interior volume. The controller is configured to receive an input indicative of a concentration of a flammable gas in the interior volume. Further, the controller is configured to control the ventilation assembly to operate the ventilation assembly in a first mode, in response to the input indicating the concentration exceeding a first threshold, to facilitate venting of the flammable gas out of the interior volume. In addition, the controller is configured to control the ventilation assembly to operate the ventilation assembly in a second mode, in response to the input indicating the concentration exceeding a second threshold higher than the first threshold, to facilitate venting of the flammable gas and deflagration out of the interior volume.

### BRIEF DESCRIPTION OF THE DRAWINGS

FIG. 1 illustrates a schematic diagram of an exemplary energy storage system devoid of at least one wall, in accordance with an embodiment of the present disclosures;

FIG. 2 is a perspective view of a ventilation assembly coupled to an enclosure of the exemplary energy storage system, in accordance with an embodiment of the present disclosure;

FIG. 3 illustrates an exploded view of the ventilation assembly, in accordance with an embodiment of the present disclosure;

FIG. 4 illustrates the ventilation assembly operating in a first mode, in accordance with an embodiment of the present disclosure;

FIG. 5 illustrates the ventilation assembly operating in a second mode, in accordance with an embodiment of the present disclosure; and

FIG. 6 is a flowchart illustrating a method for preventing explosion in the exemplary energy storage system, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

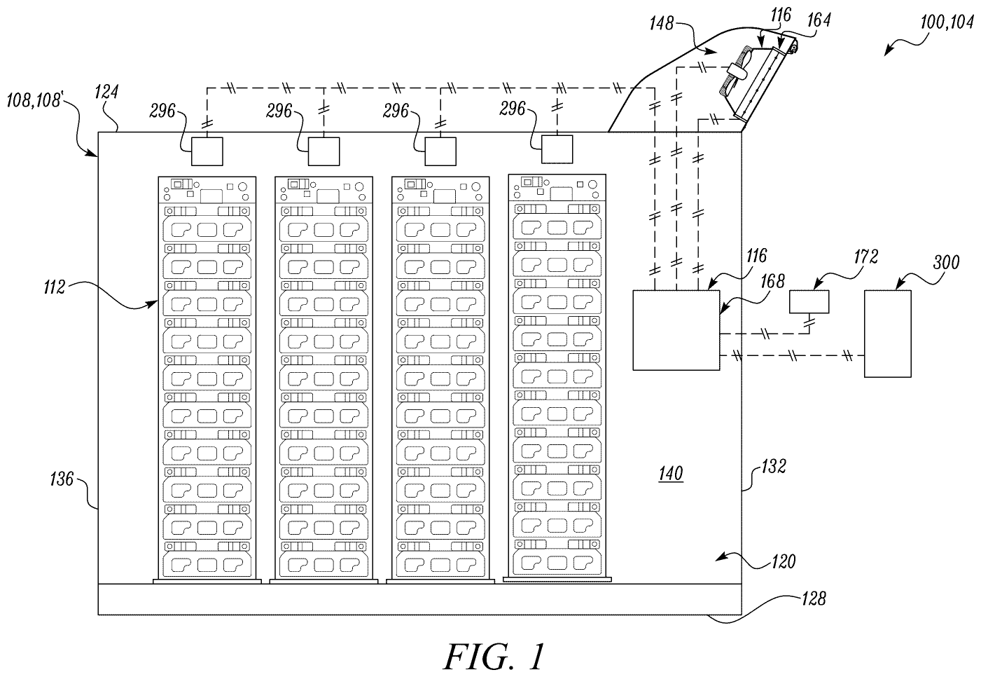

Referring to FIG. 1, an exemplary energy storage system 100 is shown. The energy storage system 100 may be used in various industries and application areas such as construction, forestry, agriculture, mining, excavation etc. In an example, as shown in FIG. 1, the energy storage system 100 is embodied as a containerized battery energy storage system (BESS) 104 that may be used to facilitate storage and/or supply of electrical energy, for example, to an electrical grid, or directly to electrical loads.

The energy storage system 100 (or the containerized battery energy storage system 104) includes an enclosure 108, one or more battery packs 112, and a ventilation system 116. It should be noted that the energy storage system 100 may also include other known electrical and/or electronic components/circuits such as, for example, rectifiers, inverters, retarders, resistor grids, switches, communication buses, and the like. However, such other known electrical and/or electronic components/circuits are not discussed herein, for the sake of brevity. Each of the enclosure 108, the battery packs 112, and the ventilation system 116 is now discussed in detail.

The enclosure 108 accommodates the battery packs 112 in a manner to isolate and/or protect the battery packs 112 from outside environmental factors, such as moisture, dust, and the like. By way of non-limiting example, the enclosure 108 may be embodied as a substantially cuboid shaped structure 108′. The enclosure 108 defines an interior volume 120 for accommodating the battery packs 112. In an exemplary embodiment, as shown in FIG. 1, the enclosure 108 defines a top wall 124, a bottom wall 128, a first side wall 132, a second side wall 136, a first face wall 140, and a second face wall (removed from FIG. 1 to show the interior volume 120). The top wall 124 and the bottom wall 128 may be disposed parallel to and spaced apart from each other. Each of the first side wall 132 and the second side wall 136 may be disposed perpendicular to the top wall 124 and the bottom wall 128. Also, the first side wall 132 and the second side wall 136 may be disposed parallel to and spaced apart from each other. Each of the first face wall 140 and the second face wall may be disposed perpendicular to the top wall 124, the bottom wall 128, the first side wall 132, and the second side wall 136. In addition, the first face wall 140 and the second face wall are disposed parallel to and spaced apart from each other. The top wall 124, the bottom wall 128, the first side wall 132, the second side wall 136, the first face wall 140, and the second face wall are coupled (e.g., welded) to each other to define the interior volume 120 of the enclosure 108.

The enclosure 108 may be provided with an inlet (not shown) for allowing outside air (or gas) to enter the interior volume 120. In addition, the enclosure 108 is provided with an outlet 144 (as shown in FIG. 1) for allowing air, or gases (e.g., flammable gas or mixture), or deflagrations to exit from the interior volume 120. The outlet 144 may be defined at a passage 148 fluidly coupled with the interior volume 120 of the enclosure 108. For example, as shown in FIG. 1, the passage 148 may extend outwardly from the top wall 124 of the enclosure 108. It should be noted that, in some embodiments, the passage 148 may be defined at any suitable location on the enclosure 108.

The battery packs 112 are configured to store and and/or supply electrical energy, for example, to an electrical grid, or directly to electrical loads. The battery packs 112 are accommodated in the interior volume 120 of the enclosure 108. In the exemplary energy storage system 100, four battery packs 112 are accommodated within the interior volume 120. However, it should be noted that a higher or a lower number of battery packs may be accommodated in the interior volume 120, based on the application requirements of the energy storage system 100.

For explanatory purposes, a battery pack 152 (of the battery packs 112) will be explained in detail with reference to FIG. 1. However, it should be noted that the description provided below for the battery pack 152 may be equally applicable to the remaining battery packs, without any limitations. The battery pack 152 may include a housing 156 and multiple battery modules 160 (each battery module 160 formed of one or more energy storage cells (not shown)) arranged in a stacked relationship within the housing 156. As shown in FIG. 1, the battery pack 152 is formed of multiple rows of the battery modules 160 that are electrically coupled to one another to provide a desired electrical energy output and voltage output. It may be contemplated that, in other embodiments, the battery pack 152 may include a higher or lower number of battery modules 160, each including a suitable number of energy storage cells, depending on energy storage and supply capacity of the energy storage system 100. Further, in some embodiments, the structure and configuration of the remaining battery packs 112 may be different from that of the battery pack 152.

The energy storage cells, of these battery modules 160, are susceptible to failures, such as thermal runaway, for example, due to a short circuit within the energy storage cell, improper usage, physical mishandling, manufacturing defects, or the exposure of the energy storage cell to extreme external temperatures. Such failures of the energy storage cells may lead to the release of high-temperature, flammable gases inside the enclosure. Thermal runaway in single energy storage cell of the battery pack (e.g., the battery pack 152) may trigger fire propagation (e.g., deflagration) throughout the entirety of the battery pack 112, thereby causing significant damage to the energy storage system 100 and possibly endangerment to personnel.

To vent the high-temperature, flammable gases and/or deflagration out of the enclosure 108 (of the energy storage system 100), in one or more aspect of the present disclosure, the ventilation system 116 is provided. The ventilation system 116 includes a ventilation assembly 164 and a controller 168. Further, the ventilation system 116 may include a switch 172. Details related to each of the ventilation assembly 164, the controller 168, and the switch 172 will now be discussed.

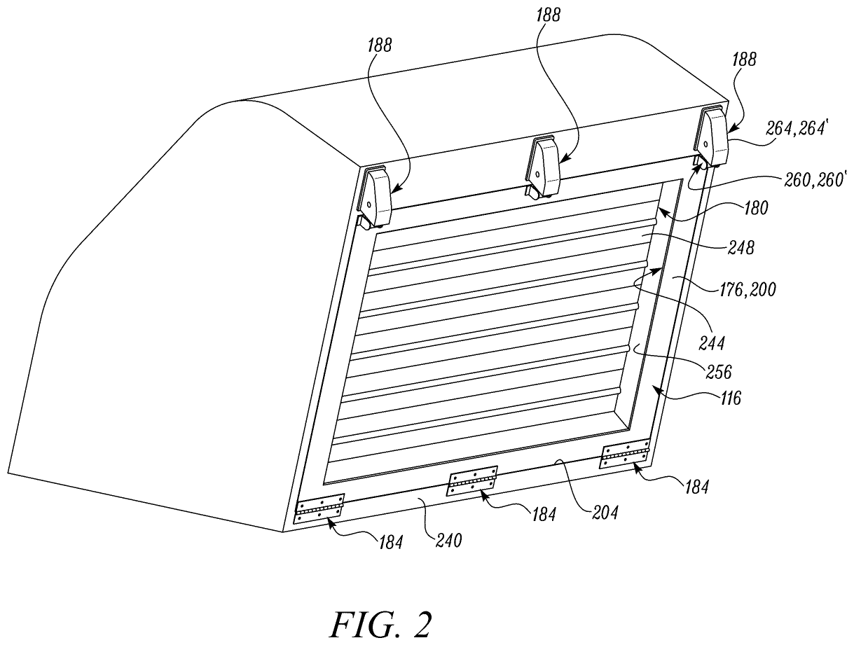

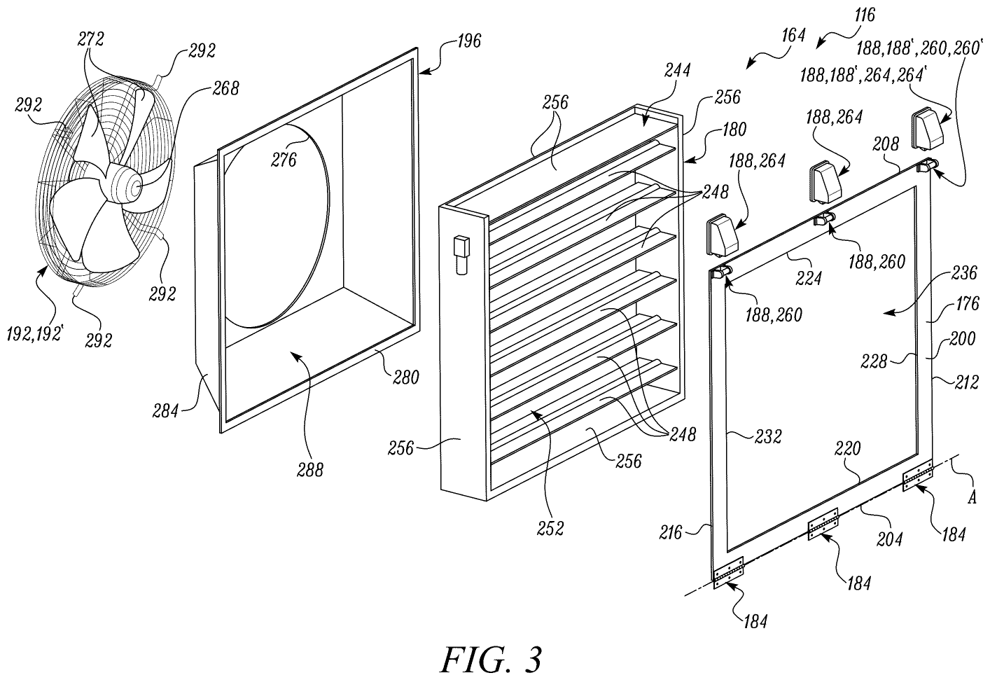

Referring to FIGS. 2 and 3, the ventilation assembly 164 includes a panel 176, a damper 180, one or more hinges 184, a latching mechanism 188, a blower 192, and a duct 196. The panel 176 may include a plate 200 having a flat shape. The panel 176 may be rectangularly shaped plate defined by four sides—a first side 204, a second side 208, a third side 212, and a fourth side 216. In the present embodiment, all the four sides of the panel, i.e., the first side 204, the second side 208, the third side 212, and the fourth side 216 may include a linear profile. The first side 204 and the second side 208 may be disposed spaced apart and parallel to one another. Similarly, the third side 212 and the fourth side 216 may be disposed spaced apart and parallel to one another. Also, the first side 204 and the second side 208 may be orthogonally oriented with respect to the third side 212 and the fourth side 216.

The panel 176 may include four inner edges—a first inner edge 220, a second inner edge 224, a third inner edge 228, and a fourth inner edge 232, to form an opening 236 of the panel 176. In the present embodiment, all inner edges, i.e.,—the first inner edge 220, the second inner edge 224, the third inner edge 228, and the fourth inner edge 232 may include a linear profile. The first inner edge 220 and the second inner edge 224 may be disposed spaced apart and parallel to one another. The third inner edge 228 and the fourth inner edge 232 may be disposed spaced apart and parallel to one another. In addition, the third inner edge 228 and the fourth inner edge 232 may be orthogonally oriented with respect to the first inner edge 220 and the second inner edge 224.

The opening 236 may define a rectangular profile. It is contemplated, however, that the opening 236 may have triangular, square, rhomboidal, trapezoidal, or any other suitable shape known in the art such that a desired quantity of flammable gas or deflagrations may be vent out of the interior volume 120 of the enclosure 108 (of the energy storage system 100). Further, it should be noted that, although the panel 176 is described to include a flat plate 200 having sides and inner edges with linear profiles, in other embodiments, the panel 176 may be formed of sides and inner edges of any known non-linear profile based on application requirements.

The panel 176 is configured to be mounted to the enclosure 108. As shown in FIGS. 1 and 2, the first side 204 of the panel 176 is coupled to at least one wall, i.e., to a wall 240 defining the outlet 144 of the enclosure 108, via hinges 184. In an exemplary assembly, as shown in FIG. 2, three hinges 184 are connected between the panel 176 (i.e., at the first side 204 of the panel 176) and the wall 240 to pivotally connect the panel 176 to the wall 240. In other examples, more or fewer hinges, including, for example, two hinges 184 and four hinges 184 may be connected to the panel 176 and the wall 240.

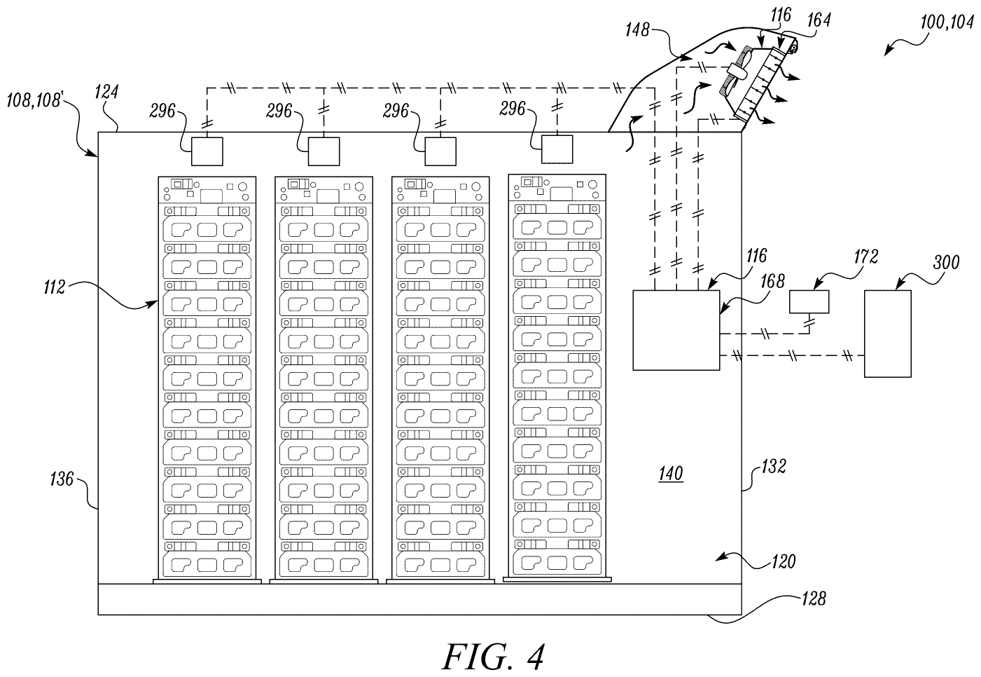

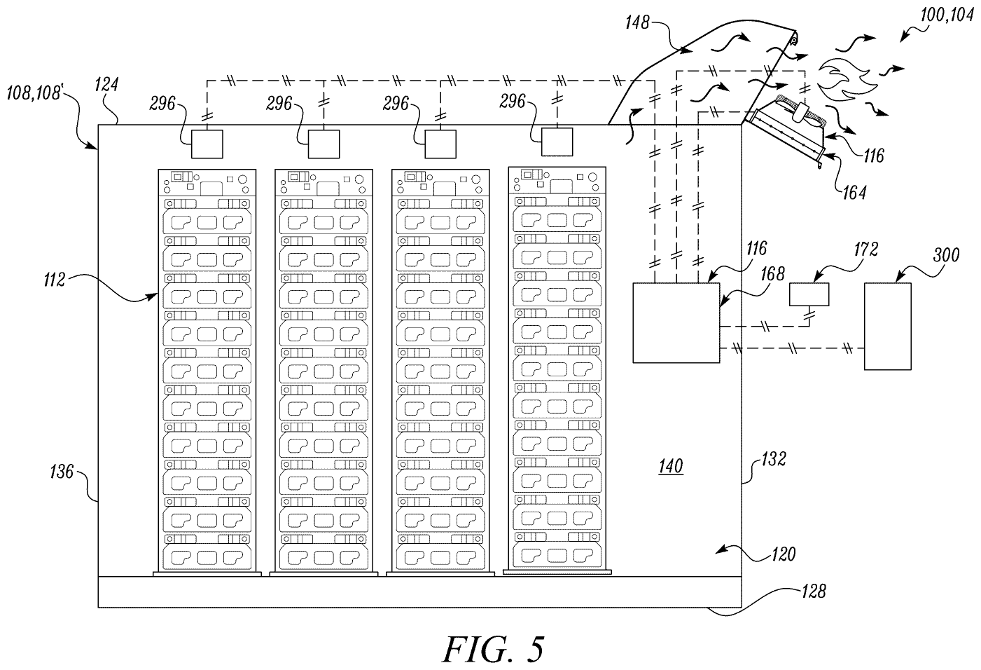

Once connected to the panel 176 and the wall 240, the hinges 184 may allow the panel 176 to pivot (about an axis ‘A’) relative to the wall 240 between a locked position (as shown in FIGS. 1 and 4) and an unlocked (or released) position (as shown in FIG. 5). In the locked position, the panel 176 may facilitate venting of the flammable gas out of the interior volume 120 of the enclosure 108. In the unlocked position, the panel 176 may facilitate venting of the flammable gas and the deflagrations out of the interior volume 120 of the enclosure 108.

The hinges 184 may be any known hinge that is capable of pivoting the panel 176 with respect to the wall 240 of the enclosure 108. For example, the hinges 184 may be selected from at least one of a barrel hinge, a pivot hinge, a butt hinge, a case hinge, a piano hinge, a concealed hinge, a butterfly hinge, a flag hinge, or a strap hinge. Additionally, in some embodiments, the hinges 184 may include biasing means (e.g., torsion spring) that may bias the panel 176 toward the unlocked position, once the panel 176 is released upon actuation of the latching mechanism 188 (discussed below).

The damper 180 may be coupled to the panel 176. The damper 180 may be configured to control a flow of the flammable gas from the interior volume 120 toward the outlet 144 of the enclosure 108. For that, the damper 180 may be configured to move between a closed state (as shown in FIG. 1) and an open state (as shown in FIG. 4). In the closed state, the damper 180 may restrict the flammable gas (from the interior volume 120) to pass through the opening 236 and vent out of the interior volume 120 of the enclosure 108 via the outlet 144. In the open state, the damper 180 may allow the flammable gas (from the interior volume) to pass through the opening 236 and vent out of the interior volume 120 of the enclosure 108 via the outlet 144.

In the present embodiment, as shown in FIG. 3, the damper 180 may include a body 244 and one or more louver blades 248. The body 244 may include a window 252 and sidewalls 256 surrounding the window 252. The window 252 may have a rectangular profile, however, it may be contemplated that the window 252 may have triangular, square, rhomboidal, trapezoidal, or any other suitable shape known in the art such that a desired quantity of flammable gas or deflagrations may be vent out of the interior volume 120 of the enclosure 108 (of the energy storage system 100). In an exemplary assembly of the damper 180 and the panel 176, the body 244 of the damper 180 may be welded to the plate 200 of the panel 176. In another exemplary assembly of the damper 180 and the panel 176, the body 244 of the damper 180 and the plate 200 of the panel 176 may be fastened together, via fasteners.

The louver blades 248 may be pivotally coupled to the body 244. In an exemplary coupling of the louver blades 248 with the body 244, as shown in FIG. 3, the louver blades 248 may be disposed within the window 252 and pivotally coupled to the sidewalls 256 surrounding the window 252. The louver blades 248 may be controlled to move between a plurality of orientations, including a first orientation (as shown in FIG. 1) and a second orientation (as shown in FIG. 4). In an example, the louver blades 248 may be controlled to move to the first orientation such that the damper 180 may attain the closed state to restrict the flammable gas (from the interior volume 120) to pass through the opening 236 and vent out of the interior volume 120 of the enclosure 108 via the outlet 144. Similarly, the louver blades 248 may be controlled to move to the second orientation such that the damper 180 may attain the open state to allow the flammable gas (from the interior volume) to pass through the opening 236 and vent out of the interior volume 120 of the enclosure 108 via the outlet 144. Further, the louver blades 248 may be controlled mechanically, electronically, hydraulically, or any combination thereof.

The latching mechanism 188 may be actuated to move between a first state (as shown in FIGS. 1 and 4) and a second state (as shown in FIG. 5). In the first state, the latching mechanism 188 may be configured to retain the panel 176 (along with the damper 180 fixedly coupled to the panel 176) in the locked position relative to the wall 240 of the enclosure 108. When actuated to move from the first state to the second state, the latching mechanism 188 may be configured to disengage (or release) the panel 176 (along with the damper 180) from the wall 240, causing the panel 176 to move from the locked position to the unlocked position. In the present embodiment, the latching mechanism 188 may be a pressure actuated latching mechanism 188′ configured to be actuated in response to a gaseous pressure within the interior volume 120 exceeding a predefined pressure.

In an exemplary embodiment, as shown in FIGS. 2 and 3, the latching mechanism 188 may include one or more latch strikers 260 and one or more latch actuators 264. In an exemplary embodiment, the latching mechanism 188 includes three latch strikers 260 and three corresponding latch actuators 264. For explanatory purpose, one latch striker 260′ and one latch actuator 264′ will be explained in detail with reference to FIGS. 2 and 3, and it should be noted that the description provided below for the latch striker 260′ and the latch actuator 264′ may be equally applicable to the remaining latch strikers 260 and the latch actuators 264, without any limitations.

The latch striker 260′ may include any surface configured to enable latching (e.g., loop, hook, etc.) and may be affixed to the plate 200 of the panel 176, for example, via welding connections, or any suitable fastening device (e.g., bolts). The latch striker 260′ may be mounted to the plate 200 at any side other than the side of the plate 200 where the hinges 184 are connected to the panel 176, i.e., other than the first side 204 of the panel 176. For example, as shown in FIG. 3, the latch striker 260′ is mounted to the plate 200 at locations proximal to the second side 208 of the panel 176.

Further, the latch actuator 264′ may be mounted to the wall 240 (of the enclosure 108). The latch actuator 264′ may be configured to be releasably engaged with the latch striker 260′ to lock or unlock the panel 176 with respect to the wall 240 of the enclosure 108. In an example, the latch actuator 264′ may be moved to a first position to contact and engage with the latch striker 260′, to retain the panel 176 in the locked position relative to the wall 240. In another example, the latch actuator 264′ may be actuated, for example, in response to the gaseous pressure within the interior volume 120 exceeding the predefined pressure, to move to a second position (from the first position) to disengage the latch actuator 264′ from the latch striker 260′. The disengagement of the latch actuator 264′ from the latch striker 260′ may facilitate the panel 176 (along with the damper 180) to move to its unlocked position.

Although in the illustrated embodiment of FIGS. 1-3, the latching mechanism 188 is shown as the pressure actuated latching mechanism 188′ having the latch striker 260′ and the latch actuator 264′, it should be noted that, in some embodiments, the latching mechanism 188 may be selected from any suitable latching mechanism already known in the art, without departing from the scope of the present disclosure.

The blower 192 may be fluidly coupled to the interior volume 120 and the damper 180. The blower 192 may be located downstream of the interior volume 120 and upstream of the outlet 144. It should be noted that the terms “upstream” and “downstream” are defined with respect to the flow of the flammable gas from the interior volume 120 toward the outlet 144 of the enclosure 108. In an example, as shown in FIG. 1, the blower 192 is positioned in the passage 148 of the enclosure 108. The blower 192 may be fixedly coupled to the damper 180. In the present embodiment, the blower 192 is fixedly coupled to the duct 196 (discussed below), which in turn, is fixedly coupled to the body 244 of the damper 180. In some embodiments, the blower 192 may be directly coupled to the damper 180.

Further, as shown in FIG. 3, the blower 192 is embodied as a fan 192′ that includes a hub portion 268 and blades 272 extending radially outwardly from the hub portion 268. The blades 272 (upon activation of the fan 192) may be rotated about an axis to produce (or direct) a flow of the flammable gas in a direction from the interior volume 120 towards the outlet 144 to facilitate venting of the flammable gas out of the enclosure 108. Furthermore, the fan 192′ may be a variable speed fan or a fixed speed fan, depending upon the application requirements.

The duct 196 may extend between the blower 192 and the damper 180 to couple the blower 192 and the damper 180. In an example, as shown in FIG. 3, the duct 196 may define a first end portion 276, a second end portion 280, and sidewalls 284 extending between the first end portion 276 and the second end portion 280 to couple the first end portion 276 with the second end portion 280. The first end portion 276, the second end portion 280, and the sidewalls 284 combinedly define a passageway 288 of the duct 196. The passageway 288 (of the duct 196) may be fluidly coupled to the blower 192 and the damper 180, for example, to receive the flammable gas directed from the blower 192 and route the flammable gas towards the damper 180.

In an exemplary assembly of the duct 196, the blower 192, and the damper 180, mounting portions 292 of the blower 192 may be fixedly coupled (e.g., welded, or fastened) to the first end portion 276 such that the passageway 288 is in fluid communication with the blower 192. Further, in the assembly of the duct 196, the blower 192, and the damper 180, the second end portion 280 of the duct 196 may be fixedly coupled (e.g., welded, or fastened) to the body 244 of the damper 180.

The controller 168 is now discussed. The controller 168 may be an electronic controller that operates in a logical fashion to perform operations, execute control algorithms, store, and retrieve data and other desired operations. The controller 168 may include or access memory, secondary storage devices, processors, and any other components for running an application. The memory and secondary storage devices may be in the form of read-only memory (ROM) or random-access memory (RAM) or integrated circuitry that is accessible by the controller 168. Various other circuits may be associated with the controller 168 such as power supply circuitry, signal conditioning circuitry, driver circuitry, and other types of circuitry.

The controller 168 may be a single controller or may include more than one controller disposed to control various functions and/or features of the ventilation system 116 and/or the energy storage system 100. The term “controller” is meant to be used in its broadest sense to include one or more controllers and/or microprocessors that may be associated with the ventilation system 116 and/or the energy storage system 100, and that may cooperate in controlling various functions and operations of the ventilation system 116 and/or the energy storage system 100. The functionality of the controller 168 may be implemented in hardware and/or software without regard to the functionality. The controller 168 may rely on one or more data maps relating to the operating conditions and the operating environment of the ventilation system 116 and/or the energy storage system 100 that may be stored in the memory of or associated with the controller 168. Each of these data maps may include a collection of data in the form of tables, graphs, and/or equations.

The controller 168 is communicably coupled with the ventilation system 116. For example, the controller 168 is communicably coupled with the damper 180 and the blower 192 of the ventilation assembly 164 (of the ventilation system 116). As an example, by way of the controller's 168 communicable coupling with the damper 180 and the blower 192, the controller 168 is configured to control the ventilation assembly 164 to operate in a first mode (as shown in FIG. 4) and a second mode (as shown in FIG. 5). When controlled (via the controller 168) to operate in the first mode, the ventilation assembly 164 may facilitate venting of the flammable gas out from the interior volume 120 of the enclosure 108. When controlled (via the controller 168) to operate in the second mode, the ventilation assembly 164 may facilitate venting of the flammable gas and the deflagrations out from the interior volume 120 of the enclosure 108.

To facilitate operation of the ventilation assembly 164 in the first mode, the controller 168 may actuate the damper 180 to move to its open state (e.g., from its closed state) and simultaneously activate (i.e., turn ON) the blower 192 to produce and direct the flow of the flammable gas from the interior volume 120 towards the damper 180 and the outlet 144. In the first mode, the panel 176 (along with the damper 180, the blower 192, and the duct 196) is retained (via the latching mechanism 188) in the locked position relative to the wall 240 of the enclosure 108 to facilitate venting of the flammable gas out of the interior volume 120, as shown in FIG. 4.

On the other hand, to facilitate operation of the ventilation assembly 164 in the second mode, the controller 168 may actuate the damper 180 to move to its closed state (e.g., from its open state) and simultaneously deactivate (i.e., turn OFF) the blower 192 to prevent the flammable gas to vent out of the interior volume 120, thereby raising the gaseous pressure in the interior volume 120. As the gaseous pressure in the interior volume 120 is raised to the predefined pressure, the latching mechanism 188 may be actuated to disengage the panel 176 (along with the damper 180, the blower 192, and the duct 196) from the wall 240 of the enclosure 108. Upon disengagement of the panel 176 from the wall 240, the panel 176 may be moved to its unlocked position to facilitate venting of the flammable gas and deflagration out of the interior volume 120, as shown in FIG. 5.

The controller 168 controls the ventilation assembly 164 to operate in the first mode and the second mode based on a concentration of the flammable gas present in the interior volume 120 of the enclosure 108. For that, the controller 168 is configured to receive one or more inputs indicative of the concentration of the flammable gas present in the interior volume 120. In the present embodiment, as shown in FIGS. 1, 4, and 5, a plurality of sensors 296 are disposed within the interior volume 120 of the enclosure 108. The sensors 296 may be configured to sense and generate inputs (e.g., signals) indicative of the concentration of the flammable gas in real time. In an example, the sensors 296 may be configured to sense concentrations of flammable gases such as carbon monoxide (CO), hydrogen (H₂), methane (CH₄), and the like. The sensors 296 may be arranged in the interior volume 120, for example, mounted to the top wall 124 of the enclosure 108. In other embodiments, the sensors 296 may be arranged at any suitable location within the interior volume 120 of the enclosure 108. Further, it should be noted that the types of flammable gases present within the interior volume 120 are exemplary, and other types of flammable gases (i.e., other than carbon monoxide, hydrogen, and methane) may exist depending on the type of battery packs 112 stored within the interior volume 120 of the enclosure 108.

The controller 168 may receive an input indicative of the concentration of the flammable gas (present in the interior volume 120) from the sensors 296, and accordingly, control the ventilation assembly 164 to operate either in the first mode or in the second mode. For instance, in response to the input (received from the sensors 296) indicating the concentration of the flammable gas (present within the interior volume 120) exceeding a first threshold, the controller 168 controls the ventilation assembly 164 to operate in the first mode, i.e., the controller 168 may actuate the damper 180 to move to its open state and simultaneously activate (or turn ON) the blower 192 to facilitate venting of the flammable gas out of the interior volume 120.

In another instance, in response to the input (received from the sensors 296) indicating the concentration of the flammable gas (present within the interior volume 120) exceeding a second threshold, the controller 168 controls the ventilation assembly 164 to operate in the second mode, i.e., the controller 168 may actuate the damper 180 to move to its closed state and simultaneously deactivate (or turn OFF) the blower 192 to prevent the flammable gas to vent out of the interior volume 120, thereby raising the gaseous pressure in the interior volume 120. As the gaseous pressure in the interior volume 120 is raised to the predefined pressure, the latching mechanism 188 may be actuated to disengage the panel 176 (along with the damper 180, the blower 192, and the duct 196) from the wall 240 of the enclosure 108. Upon disengagement of the panel 176 from the wall 240, the panel 176 may be moved to its unlocked position to facilitate venting of the flammable gas and deflagration out of the interior volume 120.

The first threshold and the second threshold may be pre-stored in the memory of the controller 168. In one example, the first threshold may be twenty five percent (25%) of the lower flammability limit (LFL) value of the flammable gas (or mixture) present in the interior volume 120 of the enclosure 108. In another example, the first threshold may be twenty percent (20%) of the lower flammability limit (LFL) value of the flammable gas (or mixture) present in the interior volume 120 of the enclosure 108. The “lower flammability limit” of a flammable gas (or mixture) may correspond to lowest concentration of said flammable gas (or mixture) required for ignition to occur, for example, during the thermal runaway of the energy storage cells.

Further, the second threshold is higher than the first threshold. The second threshold may be a set value defined based on shape and size of the enclosure 108, or free volume available in the interior volume 120 of the enclosure 108. In one example, the second threshold may be fifty percent (50%) of the lower flammability limit (LFL) value of the flammable gas (or mixture) present in the interior volume 120 of the enclosure 108. In another example, the second threshold may be seventy percent (70%) of the lower flammability limit (LFL) value of the flammable gas (or mixture) present in the interior volume 120 of the enclosure 108.

The switch 172 is now discussed. The switch 172 is a manual exhaust activation switch. That is, the switch 172 facilitates operator, associated with the energy storage system 100, to manually control the venting of the flammable gas (or mixture) or the remaining (if any, for example, after the deflagration event) of the flammable gas (or mixture) or flame, present in the interior volume 120 of the enclosure 108. In one example, the switch 172 may be actuated to a first position to generate a first signal to be transmitted to the controller 168. Upon receipt of the first signal, the controller 168 may control the ventilation assembly 164 to operate in its first mode, i.e., actuate the damper 180 to move in its open state and activate (or turn ON) the blower 192 to facilitate venting of the flammable gas (or mixture) or its remaining (as mentioned above) out of the interior volume 120.

In another example, the switch 172 may be actuated to a second position to generate a second signal to be transmitted to the controller 168. Upon receipt of the second signal, the controller 168 may control the ventilation assembly 164 to operate in its second mode, i.e., actuate the damper 180 to move in its closed state and deactivate (or turn OFF) the blower 192, and additionally, actuate the latching mechanism 188 to disengage the panel 176 with the wall 240, thereby allowing the panel 176 to move to its unlocked position to facilitate venting of the flammable gas (or mixture) or its remaining (as mentioned above), and deflagrations out of the interior volume 120.

Additionally, in some embodiments, the energy storage system 100 is provided with a backup power source 300. The backup power source 300 may be configured to supply electrical power to the components of the energy storage system 100, such as to the damper 180, the blower 192, the sensors 296, and the controller 168, for example, in case of failure of main power source (not shown) of the energy storage system 100 due to deflagration, or explosion.

### INDUSTRIAL APPLICABILITY

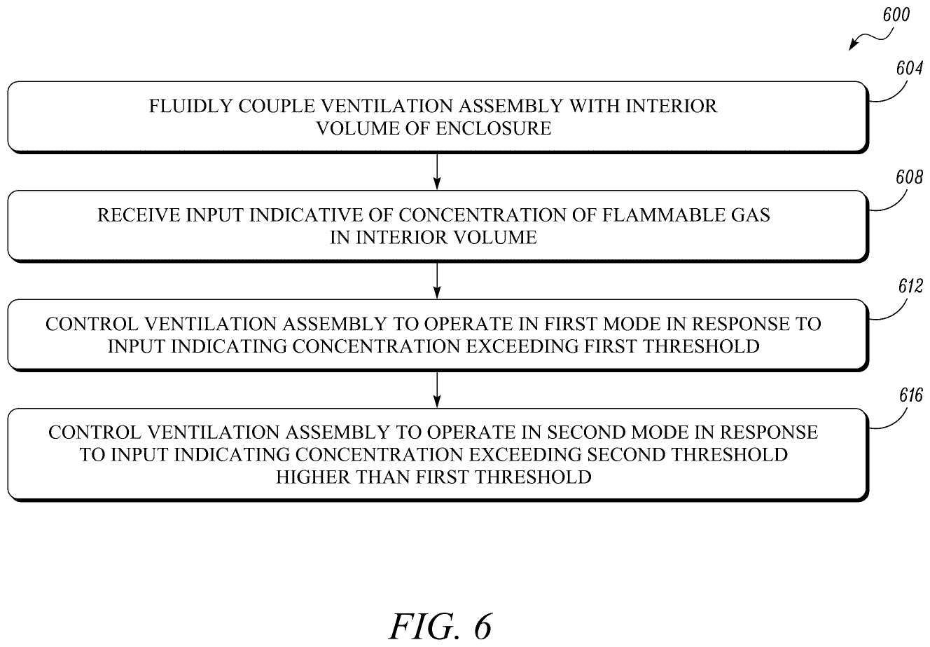

Referring to FIG. 6, an example method for preventing explosion in the energy storage system 100, using the ventilation system 116 is now discussed. The method is discussed by way of a flowchart 600 that illustrates example steps (i.e., from 604 to 612) associated with the method. The example method is also discussed in conjunction with FIGS. 1, 4, and 5.

At step 604, the ventilation assembly 164 is fluidly coupled with the interior volume 120 of the enclosure 108. For that, the ventilation assembly 164 is mounted to the wall 240 (of the enclosure 108) defining the outlet 144, as shown in FIG. 1. In an example, the ventilation assembly 164 is mounted to the wall 240 in a manner that the first side 204 of the panel 176 is pivotally coupled to corresponding portion of the wall 240, via the hinges 184, and the second side 208 of the panel 176 is releasably coupled to corresponding portion of the wall 240, via the latching mechanism 188, i.e., by releasably engaging the latch strikers 260 (affixed to the second side 208 of the panel 176) with their corresponding latch actuators 264 (mounted to the wall 240). In addition, the ventilation assembly 164 may be communicably coupled with the controller 168 of the ventilation system 116.

During an operation of the energy storage system 100, in an event of failure (e.g., thermal runaway) of one or more energy storage cells of the battery packs 112, high-temperature, flammable gases (or mixture) may be released by these within energy storage cells within the interior volume 120. The sensors 296 present in the interior volume 120 may continuously sense the concentration of the flammable gas (or mixture) in the interior volume 120 and correspondingly generate inputs (e.g., signals). The controller 168 receives the input (or signal) indicative of the concentration of the flammable gas (or mixture) in the interior volume 120, from the sensors 296, at step 608. At this stage, the panel 176 is retained by the latching mechanism 188 in the locked position relative to the wall 240, the damper is at its closed state, and the blower 192 is not active.

In response to the receipt of the input indicative of the concentration of the flammable gas (or mixture) in the interior volume 120, the controller 168 controls the ventilation assembly 164 to operate either in the first mode or in the second mode. For instance, in response to the receipt of the input indicating the concentration of the flammable gas (or mixture) exceeding the first threshold (pre-stored in the memory of the controller 168) (e.g., 25% of LFL), the controller 168 controls the ventilation assembly 164 to operate in the first mode, step 612. For that, the controller 168 actuates the damper 180 to move from its closed state to its open state and simultaneously activates (i.e., turn ON) the blower 192 to direct the flow of the flammable gas from the interior volume 120 towards the damper 180 (and the outlet 144) and vent the flammable gas out of the interior volume 120, as shown via arrows in FIG. 4. At this stage, the panel 176 (along with the damper 180, the blower 192, and the duct 196) is retained (via the latching mechanism 188) in the locked position relative to the wall 240 of the enclosure 108, as shown in FIG. 4. Venting out the flammable gas (or mixture) out of the interior volume 120 of the enclosure 108 may reduces the concentration of the flammable gas (or mixture) inside the interior volume 120.

In an event in which the concentration of the flammable gas (or mixture) within the interior volume 120 continues to increase rapidly, even when the ventilation assembly 164 is operating in the first mode, and in response to the receipt of the input indicating the concentration of the flammable gas (or mixture) exceeding the second threshold (pre-stored in the memory of the controller 168) (e.g., 60% of LFL) higher than the first threshold, the controller 168 controls the ventilation assembly 164 to operate in the second mode, step 616. For that, the controller 168 actuates the damper 180 to move to its closed state (e.g., from its open state) and simultaneously deactivates (i.e., turn OFF) the blower 192 to prevent the flammable gas (or mixture) to vent out of the interior volume 120, thereby raising the gaseous pressure in the interior volume 120. As the gaseous pressure in the interior volume 120 is raised to the predefined pressure, the latching mechanism 188 actuates to disengage the panel 176 (along with the damper 180, the blower 192, and the duct 196) from the wall 240 of the enclosure 108. Upon disengagement of the panel 176 from the wall 240, the panel 176 may be moved to its unlocked position to facilitate venting of the flammable gas (or mixture) and deflagration out of the interior volume 120, as shown in FIG. 5, thereby preventing explosion in the energy storage system 100.

The disclosed ventilation system 116 reduces the concentration of flammable gases (or mixture) present in the interior volume 120 of the enclosure 108, below 25% of LFL value (i.e., first threshold) of the flammable gases (or mixture), thereby minimizing the possibility of explosion in the energy storage system 100, for example, due to an event of failure of battery packs 112 stored in the interior volume 120 of the enclosure 108. In addition, in an event of sudden rise in the concentration of the flammable gases (or mixture), for example, beyond the first threshold (i.e., beyond 25% of LFL value), the ventilation assembly 164 (of the disclosed ventilation system 116) operates as a deflagration panel that may burst open at the predefined gaseous pressure to facilitate venting of the flammable gases (or mixture) and deflagrations out of the interior volume 120 of the enclosure 108. In this manner, the disclosed ventilation system 116 provides an efficient, cost-effective, and unified solution complying both NFPA 68 (Standard on Explosion Protection by Deflagration Venting) and NFPA 69 (Standard on Explosion Prevention Systems).

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the ventilation system, the method, and/or the energy storage system of the present disclosure without departing from the scope of the disclosure. Other embodiments will be apparent to those skilled in the art from consideration of the specification and practice of the ventilation system, the method, and/or the energy storage system disclosed herein. It is intended that the specification and examples be considered as exemplary only, with a true scope of the disclosure being indicated by the following claims and their equivalent.

What is claimed is:

1. A ventilation system for an energy storage system including an enclosure and one or more battery packs accommodated in an interior volume of the enclosure, the ventilation system comprising:
a ventilation assembly fluidly couplable with the interior volume; and
a controller configured to:
receive an input indicative of a concentration of a flammable gas in the interior volume; and
control the ventilation assembly to operate:
in a first mode, in response to the input indicating the concentration exceeding a first threshold, to facilitate venting of the flammable gas out of the interior volume, and
in a second mode, in response to the input indicating the concentration exceeding a second threshold higher than the first threshold, to facilitate venting of the flammable gas and deflagration out of the interior volume.

2. The ventilation system of claim 1, wherein the ventilation assembly includes:
a panel movable between a locked position and an unlocked position relative to at least one wall surrounding the interior volume, the panel defining an opening;
a damper coupled to the panel and configured to move between a closed state to restrict the flammable gas to pass through the opening and an open state to allow the flammable gas to pass through the opening and vent out of the interior volume; and
a latching mechanism configured to retain the panel in the locked position relative to the at least one wall to facilitate operation of the ventilation assembly in the first mode, and be actuated to disengage the panel from the at least one wall causing the panel to move from the locked position to the unlocked position to facilitate the operation of the ventilation assembly in the second mode.

3. The ventilation system of claim 2, wherein the latching mechanism is configured to be actuated in response to a gaseous pressure within the interior volume exceeding a predefined pressure.

4. The ventilation system of claim 2, wherein the ventilation assembly includes one or more hinges connected between the panel and the at least one wall of the enclosure and configured to allow the panel to pivot relative to the at least one wall between the locked position and the unlocked position.

5. The ventilation system of claim 2, wherein the ventilation assembly includes a blower fluidly coupled to the interior volume and the damper, the blower configured to be activated to direct the flammable gas from the interior volume towards the damper to facilitate the operation of the ventilation assembly in the first mode.

6. The ventilation system of claim 5, wherein the ventilation assembly includes a duct extending between the blower and the damper to couple the blower with the damper, the duct configured to receive the flammable gas directed from the blower and route the flammable gas towards the damper.

7. The ventilation system of claim 1 further including a switch manually actuable to control operation of the ventilation assembly in one of the first mode and the second mode.

8. A method for preventing explosion in an energy storage system, the energy storage system including an enclosure and one or more battery packs accommodated in an interior volume of the enclosure, the method comprising:
fluidly coupling a ventilation assembly with the interior volume of the enclosure;
receiving, by a controller, an input indicative of a concentration of a flammable gas in the interior volume; and
controlling, by the controller, the ventilation assembly to operate:
in a first mode, in response to the input indicating the concentration exceeding a first threshold, to facilitate venting of the flammable gas out of the interior volume, and
in a second mode, in response to the input indicating the concentration exceeding a second threshold higher than the first threshold, to facilitate venting of the flammable gas and deflagration out of the interior volume.

9. The method of claim 8, wherein the ventilation assembly includes:
a panel movable between a locked position and an unlocked position relative to at least one wall surrounding the interior volume, the panel defining an opening;
a damper coupled to the panel and configured to move between a closed state to restrict the flammable gas to pass through the opening and an open state to allow the flammable gas to pass through the opening and vent out of the interior volume; and
a latching mechanism configured to retain the panel in the locked position relative to the at least one wall to facilitate operation of the ventilation assembly in the first mode, and be actuated to disengage the panel from the at least one wall causing the panel to move from the locked position to the unlocked position to facilitate the operation of the ventilation assembly in the second mode.

10. The method of claim 9, wherein the latching mechanism is configured to be actuated in response to a gaseous pressure within the interior volume exceeding a predefined pressure.

11. The method of claim 9, wherein the ventilation assembly includes one or more hinges connected between the panel and the at least one wall of the enclosure and configured to allow the panel to pivot relative to the at least one wall between the locked position and the unlocked position.

12. The method of claim 9, wherein the ventilation assembly includes a blower fluidly coupled to the interior volume and the damper, the blower configured to be activated to direct the flammable gas from the interior volume towards the damper to facilitate the operation of the ventilation assembly in the first mode.

13. The method of claim 12, wherein the ventilation assembly includes a duct extending between the blower and the damper to couple the blower with the damper, the duct configured to receive the flammable gas directed from the blower and route the flammable gas towards the damper.

14. The method of claim 13, wherein controlling the ventilation assembly to operate in the first mode includes:
actuating the damper to move from the closed state to the open state and activating the blower to direct the flammable gas from the interior volume towards the damper and the opening for venting the flammable gas out of the interior volume,
wherein, in the first mode, the panel is retained in the locked position relative to the at least one wall of the enclosure.

15. The method of claim 14, wherein controlling the ventilation assembly to operate in the second mode includes:
actuating the damper to move from the open state to the closed state and deactivating the blower to raise a gaseous pressure within the interior volume to a predefined pressure to actuate the latching mechanism,
wherein, upon actuation of the latching mechanism, the panel is disengaged from the at least one wall and is moved from the locked position to the unlocked position to facilitate venting of the flammable gas and deflagration out of the interior volume.

16. An energy storage system, comprising:
an enclosure defining an interior volume;
one or more battery packs accommodated in the interior volume; and
a ventilation system including:
a ventilation assembly fluidly couplable with the interior volume; and
a controller configured to:
receive an input indicative of a concentration of a flammable gas in the interior volume; and
control the ventilation assembly to operate:
in a first mode, in response to the input indicating the concentration exceeding a first threshold, to facilitate venting of the flammable gas out of the interior volume, and
in a second mode, in response to the input indicating the concentration exceeding a second threshold higher than the first threshold, to facilitate venting of the flammable gas and deflagration out of the interior volume.

17. The energy storage system of claim 16, wherein the ventilation assembly includes:
a panel movable between a locked position and an unlocked position relative to at least one wall surrounding the interior volume, the panel defining an opening;
a damper coupled to the panel and configured to move between a closed state to restrict the flammable gas to pass through the opening and an open state to allow the flammable gas to pass through the opening and vent out of the interior volume; and
a latching mechanism configured to retain the panel in the locked position relative to the at least one wall to facilitate operation of the ventilation assembly in the first mode, and be actuated to disengage the panel from the at least one wall causing the panel with the damper to move from the locked position to the unlocked position to facilitate the operation of the ventilation assembly in the second mode.

18. The energy storage system of claim 17, wherein the latching mechanism is configured to be actuated in response to a gaseous pressure within the interior volume exceeding a predefined pressure.

19. The energy storage system of claim 17, wherein the ventilation assembly includes one or more hinges connected between the panel and the at least one wall of the enclosure and configured to allow the panel to pivot relative to the at least one wall between the locked position and the unlocked position.

20. The energy storage system of claim 17, wherein the ventilation assembly includes:
a blower fluidly coupled to the interior volume and the damper, the blower is configured to be activated to direct the flammable gas from the interior volume towards the damper to facilitate the operation of the ventilation assembly in the first mode; and
a duct extending between the blower and the damper to couple the blower with the damper, the duct is configured to receive the flammable gas directed from the blower and route the flammable gas towards the damper.
